(19) United States
(12) Patent Application Publication
(10) Pub. No.: US 2023/0005348 A1
(43) Pub. Date: Jan. 5, 2023

(54) FRAUD DETECTION SYSTEM AND METHOD

(71) Applicant: KNAP, Biot (FR)

(72) Inventors: Dylan LETIERCE, Peymeinade (FR); Jonathan MALGOGNE, Auribeau (FR); Christophe CHALOIN, Le Cannet (FR); Damien MANDRIOLI, Villeneuve Loubet (FR)

(21) Appl. No.: 17/782,435

(22) PCT Filed: Dec. 3, 2020
(86) PCT No.: PCT/EP2020/084359

§ 371 Date: Jul. 5, 2022

(30) Foreign Application Priority Data
Dec. 5, 2019 (FR) FR1913824

(51) Int. Cl. G08B 13/22

(52) U.S. Cl. CPC G08B 13/22

(57) ABSTRACT

A method for detecting fraud in the event of the purchase of at least one item by at least one user, the method including at least a step of capturing a plurality of data, including at least the following steps, a step of processing, by the computer processing unit, the plurality of data, including at least the following steps, a step of determining a probability of fraud.

### TECHNICAL FIELD OF THE INVENTION

The present invention relates to the field of fraud detection when purchasing items. It finds a particularly advantageous application in the field of mass distribution and carts, smart shopping baskets or cash register devices.

### PRIOR ART

There are several ways to check up whether an item is not stolen. Currently, the most exploited technology concerns the so-called RFID technology. There are also systems for validating shopping carts by analysing the weight of each item added to the cart.

However, this type of solution is on the one hand very expensive and/or unreliable. Indeed, fraudsters are constantly imagining new ways to circumvent the anti-fraud systems put in place in supermarkets, for example.

Hence, an object of the present invention is to propose a solution to at least some of these problems.

The other objects, features and advantages of the present invention will become apparent from a review of the following description and the appended drawings. It should be understood that other benefits may be incorporated.

### SUMMARY OF THE INVENTION

The present invention relates to a method for detecting fraud in the event of the purchase by at least one user of at least one item comprising at least:
A capturing step, performed by at least one user terminal, of a plurality of data from at least one sensor, and preferably from a plurality of sensors, comprising at least the following steps:
   i. Obtainment of an identifier of the item by at least one identification device;
   ii. Determination by at least one optical device of at least one trajectory of the item manually moved by the user in a three-dimensional space, said three-dimensional space comprising at least:
      1. An identification area corresponding to a volume of the three-dimensional space in which at least one portion of the item is disposed by the user to obtain the identifier of the item;
      2. An entrance area corresponding to a volume of the three-dimensional space crossed by the item when the user deposits the item in at least one container associated with the user terminal;
   iii. Sending by the user terminal to at least one computer processing unit of:
      1. the identifier of the item from the identification device;
      2. the trajectory of the item;
A processing step performed by the computer processing unit, of the plurality of data comprising at least the following steps:
   i. Generation of at least one behaviour of said item from at least the trajectory of the item in the three-dimensional space;
   ii. Comparison of the behaviour of said item with a plurality of predetermined behaviour models so as to identify a handling anomaly;
A step of determining a probability of fraud as a function of said behaviour comparison.

The present invention cleverly uses a plurality of sensors to cross-check a plurality of data so as to identify a fraud situation.

For example, the proposed process allows identifying a manipulation made by the user consisting in adding an item without identifying and therefore counting it at first. In this case, the item is not identified by the user before reaching the entrance area and being placed in the container.

Advantageously, the present invention allows determining the behaviour of an item so as to identify whether or not this behaviour is consistent with a behaviour considered as standard, i.e. non-fraudulent. In a simple and reliable manner, the present invention allows classifying a behaviour as potentially fraudulent behaviour as long as it deviates beyond a predetermined threshold from one or several standard behaviour model(s). The present invention cleverly uses a plurality of predetermined behaviour models comprising one or several standard behaviour model(s).

The present invention allows detecting a plurality of frauds when purchasing an item in a store, for example using automatic checkout systems for example, or else so-called smart carts.

The present invention solves most, if not all, fraud situations.

The present invention allows guiding the customer during his purchase process and identifying fraud or errors without the user automatically receiving notification. Since the contents of the cart are checked almost in real-time, payment without passing through a checkout or terminal and without direct control of all of the contents of a cart is therefore possible thanks to the present invention.

Since the calculation of the probability of fraud is done on items and/or actions, if one or several fraud(s) are suspected, the customers will be checked only on one or several item(s) and not on the entire cart.

This could allow the user to have more information on his purchases, whether this information relates to the items but also the price of his basket.

In a particularly advantageous manner, the step of capturing a plurality of data comprises at least one measurement, by at least one measuring device, of the weight of the item, and a step of sending by the user terminal to the computer processing unit the measured weight of the item.

Preferably, the processing step comprises, preferably before the step of generating the behaviour of the item, at least the following steps:
a. Identification in at least one database of the item from the identifier, the database comprising at least the identifier of the item associated with a predetermined weight of the item;
b. Obtainment of the predetermined weight of the item from the database:
   i. In the event that the predetermined weight is equal to zero or is not input, the computer processing unit assigns the measured weight of the item as the predetermined weight associated with said identifier in the database;
   ii. In the case where the predetermined weight is different from zero and input, the computer processing unit performs a comparison of the predetermined weight and the measured weight so as to identify a weight anomaly if the weight difference is greater than a predetermined threshold.

Advantageously, the determination of a probability of fraud is carried out according to said comparison of the predetermined weight with the measured weight, this probability being non-zero if a weight anomaly has been identified.

By smartly coupling an analysis of the weight and the image, the present invention allows reducing, and possibly avoiding, any fraud.

The present invention also relates to a system for detecting at least one fraud in the event of the purchase by a user of at least one item in a store, comprising at least:
A user terminal comprising at least:
   i. An identification device configured to identify the item when a user passes the item in the proximity, preferably within one meter, of the identification device;
   ii. A measuring device configured to measure the weight of the item;
   iii. An optical device configured at least to determine at least one trajectory of the item manually moved by the user in the three-dimensional space;
A computer processing unit in communication with at least the user terminal, the computer processing unit being remote or not from the user terminal and being configured to:
   i. Generate at least one behaviour of said item at least from the trajectory of the item in the three-dimensional space;
   ii. Compare the behaviour of said item with a plurality of predetermined behaviour models so as to identify a handling anomaly;

So as to determine a probability of fraud as a function of said behaviour comparison, this probability being non-zero if a handling anomaly has been identified.

Advantageously, the computer processing unit is further in communication with a database comprising the identifier of the item associated with a predetermined weight of the item.

Preferably, the computer processing unit is further in communication with a data comparison module configured to compare the measured weight with the weight indicated in the database according to the identified item, the comparison module being configured to identify a weighing anomaly.

Advantageously, the optical device is configured to further collect a plurality of images of the item, and the computer processing unit is further in communication with a module for analysing the images collected by said optical device configured to identify a handling anomaly.

Preferably, the computer processing unit is further configured to:
a. Compare the predetermined weight of the item obtained from the database with the measured weight so as to identify a weight anomaly if the weight difference is greater than a predetermined threshold;
b. Determine a probability of fraud according to said weight comparison, this probability being non-zero if a weight anomaly has been identified.

Advantageously, the computer processing unit is further configured to analyse the plurality of collected images so as to identify a handling anomaly.

The present invention also relates to a computer program product comprising instructions which, when performed by at least one processor, executes at least the steps of the method according to the present invention.

### BRIEF DESCRIPTION OF THE FIGURES

The aims, objects, as well as the features and advantages of the invention will appear better from the detailed description of an embodiment of the latter which is illustrated by the following appended drawings wherein:

FIG. 1 represents a fraud detection system according to an embodiment of the present invention.

FIG. 2 represents a diagram of the positioning of the identification device, of the optical device and of their observation areas according to an embodiment of the present invention.

FIG. 3 represents a cart integrating at least one portion of the system according to an embodiment of the present invention.

FIG. 4 represents a graphical interface of a mobile analysis device according to an embodiment of the present invention.

FIG. 5 represents an algorithm for recording data and analysing said record according to an embodiment of the present invention.

The drawings are given as examples and do not limit the invention. They form schematic representations of principle intended to facilitate understanding of the invention and are not necessarily scaled to practical applications. In particular, the dimensions are not representative of reality.

### DETAILED DESCRIPTION

Before starting a detailed review of embodiments of the invention, optional features are set out hereinafter which could possibly be used in combination or alternatively:

According to one example, the optical device is configured to allow depth to be taken into account in the capture of three-dimensional images.

According to one example, the optical device is configured to allow considering a so-called depth spatial dimension extending along an axis orthogonal to the two axes forming the plane of a dioptre of the optical device.

According to one example, the trajectory of the item in the three-dimensional space comprises at least one plurality of points, each point of said plurality of points comprising at least three spatial coordinates, preferably in an orthonormal three-dimensional space.

According to one example, the optical device is configured to allow taking into account the depth in the determination of said trajectory of the item.

According to one example, the optical device is configured to allow considering a so-called depth spatial dimension extending along an axis orthogonal to the two axes forming the plane of a dioptre of the optical device in the determination of said trajectory of the item.

According to one example, the trajectory of the item in the three-dimensional space, as determined by the optical device, comprises at least one plurality of points, each point of said plurality of points comprising at least three spatial coordinates, possibly each evolving along the trajectory, preferably in an orthogonal three-dimensional space.

According to one example, the optical device comprises a stereoscopic optical device, preferably is a stereoscopic optical device.

According to one example, the probability is non-zero if a handling anomaly is identified.

According to one example, the predetermined weight of the item contained in the database comprises a range of weights, preferably a minimum predetermined weight and a maximum predetermined weight.

According to one example, the step of determining the trajectory of the item in the three-dimensional space comprises tracking of the item in at least one area selected from at least the identification area, the entrance area, at least one external area, at least one internal area corresponding at least to the entrance of at least one container, the entrance area separating the external area from the internal area.

Dividing the space into several areas allows for better tracking of the item and for functionalisation of the space.

According to one example, the determination of the trajectory of the item in the three-dimensional space comprises at least the passages, and preferably only the passages, of the item from one area of the three-dimensional space to another area of the three-dimensional space.

According to one example, the step of determining the trajectory of the item comprises at least the determination of the trajectory of an object other than the item moving in the three-dimensional space, said object preferably being selected from: a hand, an arm, another item, a bag, an accessory worn by the user, a garment worn by the user.

According to one example, the step of generating the behaviour of the item comprises the mention of any approach of said object to the item beyond a predetermined threshold.

According to one example, the generated behaviour of said item comprises at least one sequence of events detected by the plurality of sensors, these events being selected from at least: the identification of the item, the passage from an area of the three-dimensional space to another area of the three-dimensional space, the measurement of the weight of the item, the approach of the item by another object.

According to one example, the step of capturing the plurality of data comprises the collection by the optical device of a plurality of images at least of the item and at least of one hand of the user carrying the item.

According to one example, the processing step comprises a step of analysing the plurality of collected images in order to record at least one two-dimensional representation of the item and to identify whether the user's hand is empty or full.

According to one example, the processing step comprises at least one comparison of an image of the item present in the database and one or more images of the plurality of collected images so as to identify an anomaly between the image of the item from the database and the collected image(s) of the item.

This allows comparing the scanned item not only according to its label, but also according to an optical comparison.

According to one example, the step of comparing an image of the item comprises at least one step of optical recognition of the item by the computer processing unit, preferably by a trained neural network.

According to one example, the step of collecting a plurality of images comprises at least one step of recording by the optical device a video, advantageously temporally compressed, preferably from the plurality of collected images.

This allows an event to be visualised easily, intuitively and quickly.

According to one example, the step of recording the video, preferably temporally compressed, comprises insetting data collected by at least one sensor at the time of collection of said data, said sensor being selected from at least: the identification device, the optical device, the measuring device, a spatial orientation sensor, a motion sensor.

This allows an event to be visualised easily, intuitively and quickly.

According to one example, the step of determining the trajectory of the item comprises at least:
a. The collection of a plurality of two-dimensional images, preferably in colour;
b. The collection of a plurality of three-dimensional images.

This allows identifying the geometric shape of the item and following it spatially.

According to one example, the collection of the plurality of two-dimensional images is carried out by at least one camera and by at least one additional camera, and the collection of the plurality of three-dimensional images is carried out by at least one stereoscopic camera.

According to one example, the stereoscopic camera is configured to spatially track the item in the three-dimensional space, and the additional camera is configured to transmit a plurality of two-dimensional images to at least one neural network so as to train said neural network to recognise the geometric shape of the item, preferably the database could also provide corrective data to refine the model generated by the neural network, the spatial position of the item and its geometric shape are then used to track the item by the two-dimensional camera when the item leaves the field of view of the stereoscopic camera.

The collaboration of the two cameras allows for better tracking of the item as well as better identification, thus reducing the number of possible frauds.

According to one example, the two-dimensional camera comprises an objective lens having an angle larger than 100 degrees, preferably called “wide-angle”, and is configured to ensure tracking of the spatial position of the item outside the field of view of the stereoscopic camera and to collect images of the geometric shape of the item, the spatial position of the item and its geometric shape are then used to track the item by the stereoscopic camera and by the additional two-dimensional camera when the item falls within the field of view of the stereoscopic camera.

The collaboration of the two cameras allows for better tracking of the item as well as for better identification, thus reducing the number of possible frauds.

According to one example, the method comprises, before the step of identifying the item, a step of identifying the user followed by a step of reading a user profile specific to the user from a user profile database.

This allows taking into account the user's history as a weighting parameter in the assessment of the probability of fraud.

According to one example, the predetermined behaviour models comprise at least one standard behaviour model comprising at least the following sequence of events:
a. Identification of the item;
b. Tracking the item from the identification area to the entrance area;
c. Tracking the item from the entrance area to the internal area;
d. Preferably, tracking an empty hand of the user from the internal area to the external area before or after measuring the weight of the item.

According to one example, a handling anomaly comprises at least one of the following situations: exchange of the item with another item, addition of another item in a container at the same time as said item, removal of another item from said container when depositing said item in said container, exchange of an identified item with another unidentified item, identification of an item with a fraudulent identifier.

This allows identifying anomalies other than weight-related ones, and mainly those due to handling of the item.

According to one example, the method comprises, if a weight anomaly is detected, the following steps:
a. Formulation by message, preferably visual and/or audio, to the user of a request to remove the item, this formulation being carried out by a user interface, the user interface being for example the computer processing unit;
b. Formulation by message, preferably visual and/or audio, to the user of a request to weigh the item again so as to obtain a new weight, this formulation being carried out by a user interface, the user interface being for example the computer processing unit;
c. Sending by the user terminal to the computer processing unit of the new weight of the item;
d. Processing, carried out by the computer processing unit, of the new identifier of the item, of the new weight of the item, and preferably of the collected images, comprising at least the comparison of the predetermined weight with the new measured weight so as to identify a weight anomaly.

This enables a verification of the weight of the item and thus this could reduce the interventions of the supervisors.

According to one example, the method comprises, if an anomaly is detected, the following steps:
a. Formulation by message, preferably visual and/or audio, to the user of a request to identify the item again, this formulation being carried out by a user interface, the user interface being for example the computer processing unit;
b. Sending by the user terminal to the computer processing unit of the new identifier of the item;
c. Formulation by message, preferably visual and/or audio, to the user of a request to weigh the item again so as to obtain a new weight, this formulation being carried out by a user interface, the user interface being for example the computer processing unit;
d. Sending by the user terminal to the computer processing unit of the new weight of the item;
e. Processing, by the computer processing unit, of the new identifier of the item, of the new weight of the item, and preferably of the collected images, comprising at least comparing the predetermined weight with the new measured weight so as to identify a weight anomaly.

This enables a double verification and thus it could reduce the interventions of the supervisors.

According to one example, the method comprises a continuous step of recording an initial video with a predetermined duration by the optical device, said initial video being erased at the end of said predetermined duration unless an event is detected by at least one sensor selected from at least: the identification device, the measuring device, the optical device, a motion sensor, a spatial orientation sensor.

This allows having images prior to the event triggering the recording and therefore to the relevant event.

According to one example, the processing step is carried out only when the step of capturing the at least one plurality of data is complete.

This allows saving system resources and energy. Indeed, advantageously, the collection and analysis phases are distinct so that the system could operate efficiently with little system resource, little energy and therefore at low cost.

According to one example, the method comprises, when the probability of fraud is greater than a predetermined threshold, sending from the computer processing unit of a plurality of secondary data based on said plurality of data to at least one management station so that a first supervisor analyses said plurality of secondary data.

This allows having a first automated anti-fraud filter, and a second anti-fraud filter involving one or several human operator(s).

According to one example, if a fraud situation is validated by the first supervisor, said plurality of secondary data is transmitted to at least one mobile analysis device, preferably located in the same building as the user terminal, so that a second supervisor analyses said plurality of secondary data and moves to the user.

This allows having a mobile supervisor to go on site and visually check the presence of fraud or not.

According to one example, said plurality of secondary data comprises at least one of the following data: the identifier of the item, the weight of the item, an original image of the item, one or more images of the plurality of collected images, a video, preferably temporally compressed.

This allows for a simple and intuitive presentation of information.

According to one example, the user terminal is a mobile cart.

This allows having a smart cart enabling the user to pay for his purchases easily at the end of the session, scanning of the items being done during the purchase session.

According to one example, at least one portion of the computer processing unit is embedded in the mobile cart.

According to one example, the system comprises at least one management station, preferably remote, configured to receive at least a plurality of data from the computer processing unit so as to be analysed by at least one first supervisor.

According to one example, the system comprises at least one mobile analysis device configured to receive a plurality of data from the management station so as to enable a second supervisor to analyse said plurality of data and to move to the user.

According to one example, the computer processing unit is in communication with another database comprising at least the history of detected frauds of the user.

According to one example, in which the user terminal is a fixed terminal, typically intended to be placed in a store, for example close to the exit of the store.

According to one example, the computer processing unit is in communication with at least one classification module comprising at least one neural network trained to detect a situation of fraud from data transmitted to the computer processing unit.

According to one example, the user terminal comprises at least one display device configured to display at least the identifier and/or the weight of the item.

According to one example, the system comprises at least one electric battery.

In the present description, the term “a three-dimensional space” means a space comprising at least three spatial dimensions, at least part of this space being captured by an optical device, preferably stereoscopic, configured to consider these three spatial dimensions, i.e. it is possible to determine the spatial position of one or several object(s) present in this three-dimensional space via this optical device. In particular, this optical device is configured to take into account, in addition, the depth with respect to said optical device, i.e. it is possible to assess the distance of one or several object(s) present in this three-dimensional space with respect to said optical device. Thus, in this three-dimensional space, an object could describe a trajectory and this object therefore comprises three spatial coordinates at each point of this trajectory, because the optical device is capable of assessing the evolution of said object in the three dimensions of space. This also allows for an advantageously much more flexible placement of the optical device while preserving understanding of the actions carried out in the three-dimensional space. Unlike the prior art which considers only two spatial dimensions and does not measure the depth, the optical device according to the present invention is not necessarily arranged vertically to the two-dimensional area to be assessed.

The present invention relates to a system, as well as a method for detecting fraud during the purchase of an item by a user in a store, for example.

The present invention cleverly allows the detection of fraud during the purchase of an item. Indeed, via a clever method based on an advantageous system, the present invention allows detecting fraud in the case of automatic collection, and possibly automatic payment, systems also called automatic checkouts or else automatic payment carts, for example without limitation.

We will first present the fraud detection system according to an embodiment of the present invention. Then, we will present the fraud detection method according to an embodiment of the present invention.

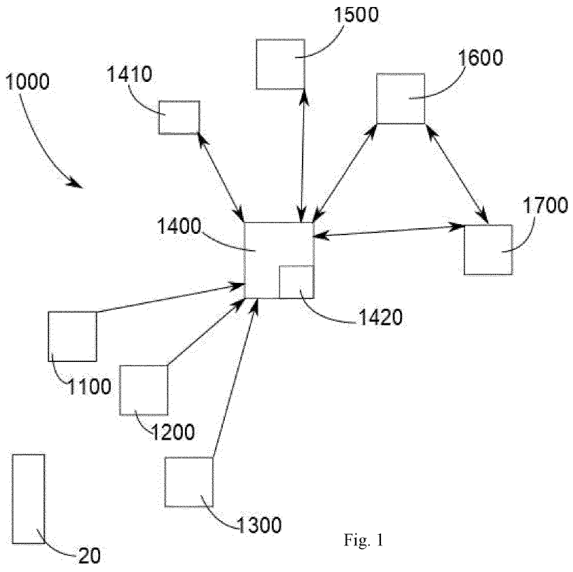

FIGS. 1 to 3 illustrate a fraud detection system according to an embodiment of the present invention.

FIG. 1 schematically illustrates such a system 1000.

Advantageously, the fraud detection system 1000 comprises at least:
a. A user terminal 10 comprising at least:
   i. An identification device 1100 configured to obtain the identifier of an item 20;
   ii. A measuring device 1200 configured to measure the weight of said item 20;
   iii. An optical device 1300 configured at least to detect and follow said item 20 in space;
   iv. Preferably, a motion sensor and/or a spatial displacement sensor, such as a gyroscope for example.
b. A computer processing unit 1400 configured to process a plurality of data and determine a probability of fraud, preferably to determine whether there is fraud or not.

According to one embodiment, the user terminal 10 comprises part or all of the computer processing unit 1400.

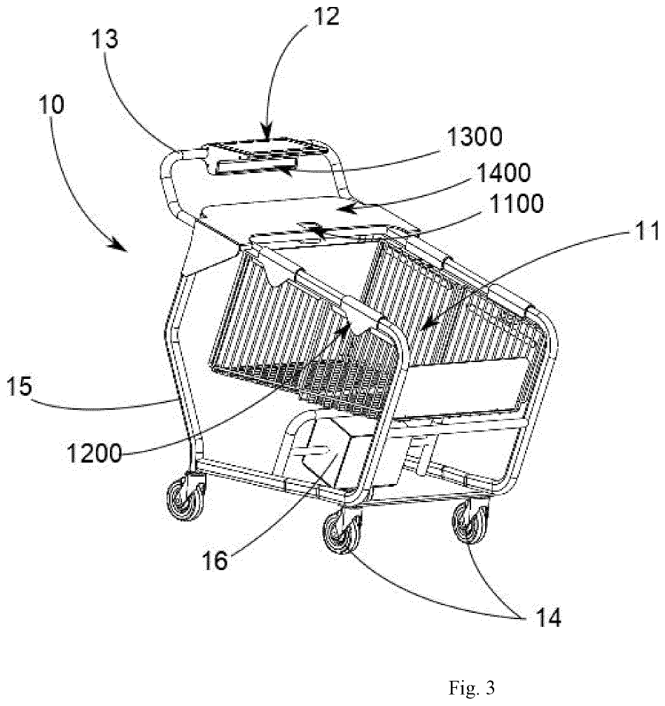

According to a preferred embodiment, the user terminal 10 is a mobile cart 10, as illustrated in FIG. 3 for example.

According to another embodiment, the user terminal is a terminal, for example a payment terminal or an automatic pay machine.

According to one embodiment, the user terminal 10 may comprise a container 11 intended to receive the item 20 after the user has identified said item 20. According to a preferred embodiment, at least the identification device 1100, the measuring device 1200 and the optical device 1300 are mounted on the same device, preferably mobile, such as for example a cart 10 as described later on in FIG. 3.

According to one embodiment, the identification device 1100 is configured to determine the identifier of the item 20. This determination may be in any form. For example, it may comprise the fact of having the identification device 1100 read the barcode of the item 20. It may be a radiofrequency technology of the RFID type or else a visual recognition of the item 20, or even a touch interface enabling the user to indicate to the system 1000 the considered item so that the identifier of the item 20 is determined. In the case of visual recognition of the item 20, the identification device 1100 may comprise the optical device 1300 and/or vice versa.

According to one embodiment, the identification device 1100 may comprise a mobile device, for example belonging to the user. In this case the identification device 1100 could use at least one camera of this mobile device to identify the item 20. For example, this mobile device may be a digital tablet or a smartphone.

Preferably, the user presents the item 20 to the identification device 1100 of the barcode reader type, for example, the identifier is obtained by the identification device 1100 then transmitted to the computer processing unit 1400. Afterwards, the user moves the item 20 into the container 11. The container 11 advantageously comprises the measuring device 1200.

According to one embodiment, the measuring device 1200 is configured to measure the weight of the item 20. Advantageously, the measuring device 1200 comprises a force sensor from which hangs the container 11 configured to receive said item 20 once it has been identified. According to one embodiment, the container 11 may be placed on the force sensor. According to another embodiment, the measuring device 1200 comprises a scale on which the item 20 is placed to measure its weight. Once the weight has been measured, this data is transmitted from the measuring device 1200 to the computer processing unit 1400.

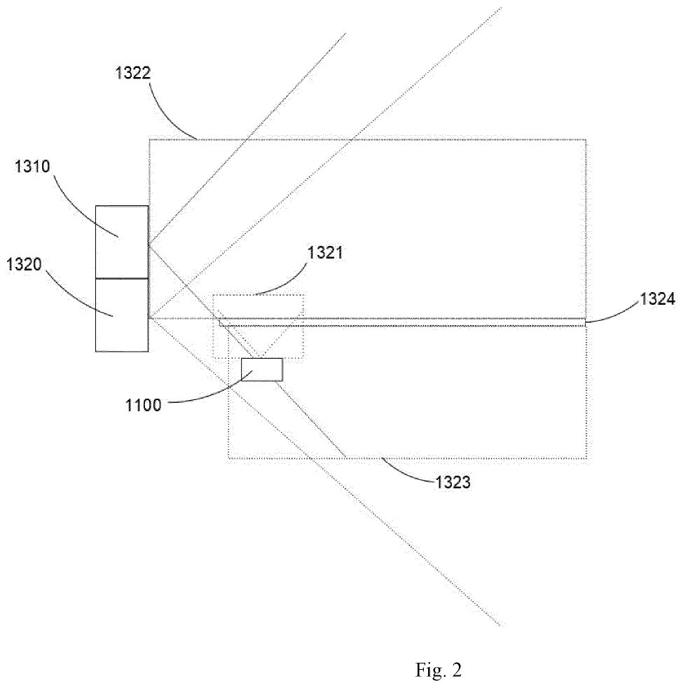

According to one embodiment, the optical device 1300 comprises a so-called two-dimensional camera 1310 configured to collect two-dimensional images of a predetermined two-dimensional scene, and preferably a stereoscopic camera also called a three-dimensional camera 1320. This stereoscopic camera, or more generally this three-dimensional sensor 1320, is configured to collect three-dimensional images of a predetermined three-dimensional scene. We will further describe the optical device 1300 later on as well as the different areas that form this predetermined three-dimensional scene, through FIG. 2. Preferably, the optical device 1300 is configured to transmit said collected images to the computer processing unit 1400.

According to one embodiment, the optical device 1300 comprises a camera.

According to one embodiment, the system 1000 may comprise a plurality of sensors, including the identification device 1100, the measuring device 1200 and the optical device 1300, but also a motion sensor for example, or else an accelerometer, or a gyroscope, or any other sensor that could be used to collect one or several data useful for identifying a potential fraud situation. As presented later on, the present invention advantageously takes advantage of the cross-checking of data collected by a plurality of sensors. This cross-checking of data is advantageously carried out by an artificial intelligence module 1420, preferably comprising at least one trained neural network, advantageously automatically.

According to one embodiment, the computer processing unit 1400 is configured to process the obtained data, collected by the identification device 1100, the measuring device 1200, the optical device 1300, and preferably by any other sensor. Indeed, preferably, the computer processing unit 1400 is configured to receive:
a. At least one identifier of said item 20 from the identification device 1100;
b. At least one measurement of the weight of said item 20 from the measuring device 1200;
c. At least a plurality of images collected by the optical device 1300.

Advantageously, the computer processing unit 1400 is in communication with at least one database 1410 comprising for each identifier at least one series of data comprising the predetermined weight of said item 20, and preferably an image or a graphical representation of said item 20. To carry out this comparison, the computer processing unit 1400 may comprise a weight comparison module for example.

According to one embodiment, the predetermined weight of the item 20 corresponds to a weight interval. Indeed, the database may comprise a weight interval and not a specific value. In particular, this avoids many situations where the weight does not accurately correspond. Indeed, it is hard that all items 20 have the same weight. On the other hand, it is perfectly possible to define a weight range in which the item 20 must be. For example, this weight range may correspond to the weight of the item 20 more or less 2%, preferably 5% and advantageously 10%. According to a preferred example, this range has a minimum value and a maximum value, preferably pre-recorded or acquired by learning during the operating time of the invention.

According to a preferred embodiment, the predetermined weight recorded in the database 1410, at least before scanning of the item 20, is zero, i.e. it is equal to zero or is not input. According to this embodiment, the system 1000 is self-learning, i.e. it will feed its database 1410 from the measured weight. For example, the user scans an item 20, the system 1000 identifies the item 20 and accesses the database 1410 of items 20 to compare the weight of said scanned item 20 with that of the database 1410. If the database returns a zero weight value or if the weight value is not input in the database 1410, then the system 1000 switches into self-learning mode and replaces this zero weight or not input value with the value of the measured weight. In this self-learning phase, the system 1000 captures images of the item 20 so that it could subsequently associate a two-dimensional image of the item 20 with the identifier of the item 20 and the weight of the item 20. If during the purchase session, the user handles said item 20, its weight, its identifier and its visual recognition will be used to prevent a situation of fraud. It should also be noted that during the first scan, the system 1000 is designed to reason logically, i.e. if the user tries to place a fruit and vegetable label on an item 20 other than fruit and vegetables, the visual analysis, described later on, allows triggering a notification of a potential situation of fraud even though the weight is not listed in the database 1410.

Preferably, as long as the weight of the item 20 is greater than a predetermined threshold, this weight may be used as a predetermined weight if, before weighing, the predetermined weight of said item in the database was zero. Advantageously, this predetermined threshold is less than 100 gr, preferably 50 gr and advantageously 25 gr.

Preferably, the computer processing unit 1400 is configured to obtain from said database 1410 at least the predetermined weight of said item 20 and to compare this predetermined weight with the measured weight transmitted by the measuring device 1200.

Advantageously, the computer processing unit 1400 is configured to process the plurality of collected images. This processing may comprise the identification and/or spatial location of the item 20. In the case of an identification, this may be used to compare the identifier of the item 20 with the optical identification carried out by the computer processing unit 1400 from the plurality of collected images.

According to one embodiment, the spatial location of the item 20 is used in order to verify that the identified item 20 is actually the weighed item 20 and that the user has not exchanged the identified item 20 with another item 20 of the same weight.

According to one embodiment, the optical device 1300 only comprises a single camera capable of capturing two-dimensional images and three-dimensional images.

Preferably, the optical device 1300 is configured to capture points in a three-dimensional space, thus allowing depth to be taken into account in the capture of three-dimensional images.

Preferably, the optical device 1300 is configured to capture two-dimensional colour data.

Advantageously, the optical device 1300 is configured to follow an object, preferably the item 20 or one or more hands of a user for example, in a space. This space is compartmentalised into various virtual areas. These virtual areas are defined by the computer processing unit 1400 and are used for the analysis of the collected images, or for triggering actions.

Thus, according to an embodiment illustrated in FIG. 2, the considered analysed three-dimensional space comprises at least four areas:
a. A scan area 1321, located at the level of the identification device, for example in front of a barcode scanner;
b. An external area 1322, located above the container 11, preferably above the cart, or outside a deposit area for an automatic scan, for example;
c. An internal area 1323, located inside the container, preferably in a so-called deposit area, advantageously in the cart;
d. An entrance area 1234, located between the external 1322 and internal 1323 areas.

The use of these areas will be described more specifically later on, as well as the clever process of processing the collected images.

According to one embodiment, the system 1000 also comprises at least one mobile fraud analysis device 1700. This device 1700 is configured to be used by a user called a supervisor, his role being to supervise some situations of possible fraud. Indeed, in a clever way, and as described later on, in case of doubt concerning a situation of fraud, a supervisor having a fraud analysis device 1700 receives thereon a plurality of information enabling him to assess whether or not there is fraud. This analysis step will be described later on, in particular its advantageous presentation allowing for a very high and reliable responsiveness from the supervisor.

According to one embodiment, the processing unit 1400 may be in communication with a management station 1600. This management station 1600 allows supervising a plurality of fraud detection systems 1000. This management station 1600 will also be described more specifically later on.

FIG. 3 illustrates a fraud detection system 1000 according to a preferred embodiment. In this figure, a cart 10 comprises a gripping device 13 and a frame 15 supported by wheels 14 thus making the cart 10 mobile.

Advantageously, the cart 10 further comprises the identification device 1100, the optical device 1300, the measuring device 1200 and at least one container 11.

Advantageously, the cart 10 may comprise at least one display device 12 enabling the user to be informed where necessary, and possibly a touch interface service for managing the user's virtual basket, for example.

According to one embodiment, the computer processing unit 1400 may be embedded in the cart 10 and/or be partially or totally shifted and be in communication with the elements embedded in the cart 10.

In this figure, the cart 10 comprises a container 11, preferably hanging from at least one force sensor thus serving as a device 1200 for measuring the weight of the item 20. Advantageously, the identification device 1100 is a barcode scanner. Preferably, the cart 10 comprises the optical device 1300 adapted to collect two-dimensional images, preferably in colour, and three-dimensional images.

According to one embodiment, the cart 10 may comprise a plurality of sensors such as, for example, a sensor of spatial position, movement, direction of movement, presence, NFC (Near Field Communication) sensor, RFID sensor (standing for radio frequency identification), LI-FI sensor (standing for Light Fidelity), Bluetooth sensor, or else WI-FI™ type radio communication sensor, etc. . . . .

According to one embodiment, the cart 10 comprises one or several Bluetooth, WI-FI™ or Lora (Long Range) type communication modules.

According to a preferred embodiment, the cart 10 comprises different sensors linked to an artificial intelligence whose purpose is to understand each action performed on the cart 10 by the user and to detect fraudulent actions. For example, this intelligence may be in the form of a data processing module comprising at least one neural network, preferably trained. This neural network may be embedded in the cart 10. Preferably, the cart 10 comprises an electric power source 16 for example to power the different elements indicated before.

We will now simply illustrate the clever operation of the present invention, for example when a user is about to add an item 20 to his virtual basket, i.e. when the user adds in the container 11 an item 20 for its subsequent purchase in a store equipped with the present invention.

In the following example and for clarity, the fraud detection system 1000 is partly at least mobile and partly at least on board a cart 10 as described before.

According to one embodiment, the system 1000 comprises an interface 12 that could either be placed on the cart 10 itself in the form of a touch interface 12, or be virtualised in the form of a mobile application that the user will have downloaded beforehand, for example, on his smartphone.

The user, after having selected the item 20 to be purchased, scans it with the identification device 1100. Preferably, the barcode of the item 20 is scanned by the identifier of the device 1100. Once the item 20 has been scanned, the user has a predetermined time, for example 10 seconds, to deposit the scanned item 20, i.e. identified, on or in the container 11. Advantageously, the container 11 is configured to cooperate with the measuring device 1200 so that the weight of the item 20 is measured by the measuring device 1200.

According to a preferred embodiment, the measuring device 1200 is embedded in the cart. Thus, the user must have the scanned item 20 in the cart 10 in less than 10 seconds, for example without limitation.

According to another embodiment, the measuring device 1200 may be externalised relative to the cart 10 so that the user, after having scanned the item 20, places the latter on or in the measuring device 1200 so that its weight is measured there, before placing the item 20 in the container 11.

Once the item 20 is placed, the measuring device 1200 determines the weight of the item 20.

According to one embodiment, before weighing, the identifier is transmitted to the computer processing unit 1400. According to another embodiment, the identifier is transmitted to the computer processing unit 1400 after weighing, and preferably at the same time as the weight is measured.

After weighing, the item 20 is added to a virtual basket allowing the system 1000 and the user to have a follow-up of the purchases of the user.

According to one embodiment, only one action is possible at a time, i.e. it is not possible to scan, or to identify, another item 20 as long as the previously scanned item 20 is not deposited and its weight has not been assessed.

Advantageously, the present invention enables the user to cancel his scan to potentially scan another item 20. In this case, either the user cancels the previous scan via the control interface 12, or he waits for the predetermined time indicated previously, for example 10 seconds.

The present invention also takes into account the situation where the user would like to remove an item 20 from the cart 10. In this case, the user uses the control interface 12 to indicate to it that he wishes to remove an item 20 from the cart 10. Afterwards, the user can remove as many items 20 as he wishes, but must preferably scan them one by one, advantageously waiting each time between each scan for the system 1000 to detect that the weight of the container 11 has varied.

In the case where an item 20 is placed or removed without a scan step, the weight variation would be detected by the system 1000, preferably by the measuring device 1200, and would be mentioned to the user, preferably via the control interface 12, also called display device 12. The same applies if the assessed weight is inconsistent with the identifier of the item 20 obtained after scanning it. The same is also true for the removal of an item 20 whose weight does not correspond to the identifier of the scanned item 20 supposed to have been removed.

Thus, the present invention is specially designed to secure the purchase of an item 20 and thus significantly reduce fraud while allowing for a better fluidity at checkout since payment is ensured directly by means of the present invention, directly via the cart 10 for example, preferably through the display device 12 which could be used as a control, and preference payment, interface 12.

We will now describe the fraud detection method according to the present invention.

According to one embodiment, the fraud detection method comprises at least:
a. A step of capturing a plurality of data. These data are at least those previously indicated. This capture step is advantageously carried out by the user terminal 10. This capture step comprises at least the following steps:
   i. Obtainment of the identifier of the item 20 by the identification device 1100; this step is for example carried out by scanning the item 20 by means of the identification device 1100; The user is invited to scan any item 20 that he wishes to place in the cart 10 for example.
   ii. Determination by the optical device 1300 of at least one trajectory of the item 20 in a three-dimensional space, the item 20 being manually moved in said three-dimensional space by a user, this trajectory is preferably manually imposed on the item 20 by a user, said three-dimensional space comprising at least:
      1. An identification area 1321 corresponding to a volume of the three-dimensional space in which at least one portion of the item 20 is placed by the user to obtain of the identifier of the item 20;
      2. An entrance area 1324 corresponding to a volume of the three-dimensional space through which the item 20 passes when the user places the item 20 in at least one container 11, preferably associated with the user terminal 10;
      3. Preferably, an internal area 1323 corresponding to the entrance of a container 11;
      4. Preferably, an external area 1322, the entrance area 1324 separating the external area 1322 from the internal area 1323. The external area 1322 advantageously corresponds to the three-dimensional space surrounding the entrance area 1324, itself surrounding the internal area 1323.
         The determination of the trajectory consists in tracking the item 20 from one area to another area and recording either the entire trajectory, or only the sequence of passage from one area to another.
         Preferably, any object within the field of view of the optical device 1300 is tracked in the three-dimensional space.
      As discussed later on, if the trajectory of an object approaches beyond a predetermined threshold the trajectory of the item 20, in other words if an object approaches the item 20 beyond a predetermined threshold, this may correspond to a situation of fraud, so the system 1000 is designed to mention during the analysis of the data later on.
   iii. Preferably, the optical device 1300 collects a plurality of images of said item 20 and/or of at least one hand of the user carrying said item 20. This collection of images lasts until the item 20 is set so that the measuring device 1200 could measure its weight; once the item 20 has been scanned, the user has a predetermined time to place the item 20 in the container 11 and thus weigh it; moreover, scanning the item 20 triggers the capture of the plurality of two-dimensional and preferably three-dimensional images; this step of collecting the plurality of images is intended to track the item 20 visually from the scan area 1321 to its deposit place in the internal area 1323; this allows, inter alia, verifying that the scanned item 20 is not exchanged with another item before being deposited in the container 11 for example.
   iv. Sending from the identification device 1100 to the computer processing unit 1400 of the identifier of the item 20;
   v. Sending from the optical device 1300 to the computer processing unit 1400 of the plurality of collected images;
   vi. Preferably, measurement, by the measuring device 1200, of the weight of the item 20, advantageously once the latter has been placed in the container 11 by the user;
   vii. Preferably, sending from the measuring device 1200 to the computer processing unit 1400 the measured weight of said item 20 from said measuring device 1200;
b. A processing step, carried out by the computer processing unit 1400, of the plurality of data, preferably of the identifier of the item 20, of the measured weight of the item 20 and of the collected images, comprising at least the following steps:
   i. Preferably, identification in the database 1410 of the item 20 from said identifier;
   ii. Preferably, obtainment of the predetermined weight of the item 20 from the database 1410; according to one embodiment, the predetermined weight of the item 20 contained in the database during the first scan of the item 20 could be equal to zero or not be input;
   iii. Preferably, comparison of the predetermined weight with the measured weight so as to identify a weight anomaly; preferably, a weight anomaly corresponds to a measured weight different from the predetermined weight found in the database 1410 with the exception of the situation where the predetermined weight is equal to zero or is not input; otherwise, beyond a weight difference greater than a predetermined threshold, a weight anomaly is considered; this weight anomaly may occur when the user exchanges the scanned item 20 with another item whose weight is different, or when he modifies the barcode for example in order to scan an item with a weight different from the deposited actual item. In the case of a predetermined weight equal to zero or not input, the present invention is configured to replace this value with the value of the measured weight, this measured weight value then becoming the value of the predetermined weight during, at least, the remainder of the user's purchase session.
   iv. Generation of at least one behaviour of said item 20 from at least the trajectory of the item 20 in the three-dimensional space; This step consists in aggregating various measurements from various sensors so as to recreate a behaviour of the item 20 evolving in a three-dimensional space but also in a sensor space. If the sequence of measurements is not consistent with at least one model among a plurality of standard behaviour models, then there is a suspicion of fraud, and a handling anomaly is detected; Preferably, a behaviour is not consistent with a standard behaviour model from the time point it presents a deviation from this model by more than 2%, preferably 5% and advantageously 10%; Advantageously, a behaviour is not consistent with a standard behaviour model from the time point some key events of the model are not present in the generated behaviour, such key events may for example be the fact that the item 20 has not been identified, that the item 20 has not been deposited, that the item 20 has not crossed the entrance area 1324, etc . . . ; Preferably, a behaviour is not consistent with a standard behaviour model from the time point that some suspicious events are present in the generated behaviour, such suspicious events may for example be the fact that the optical device is temporarily obstructed, or else an object has approached the item 20, etc. . . .
   v. Comparison of the behaviour of said item with a plurality of predetermined behaviour models, said generated behaviour comprising at least the trajectory of said item in the three-dimensional space, if the behaviour is different from each model of predetermined behaviours, then a handling anomaly is identified; It should be noted that advantageously, the system is configured to learn from each situation and thus add and/or modify its standard behaviour models;
   vi. Preferably, analysis of the plurality of collected images so as to identify a handling anomaly; a handling anomaly consists, for example, in scanning an item and depositing another of the same weight, or else in scanning an item with a label that does not correspond to said item even though the weight is correct; visual and preferably automated analysis is necessary for this type of situation, this analysis is provided by the present invention; advantageously, the computer processing unit 1400 comprises an artificial intelligence module 1420 comprising at least one neural network, advantageously trained to determine handling anomalies; In a particularly advantageous manner, the analysis of the plurality of collected images consists of an analysis of a three-dimensional scene and in particular of the displacement of a plurality of points associated with the item 20 in a three-dimensional space split into different areas; these areas will be described later on. The principle of this analysis of the plurality of images is to determine whether the movement of the item 20 in space corresponds to a predetermined model selected from among a plurality of models deemed to be non-fraudulent which will be described subsequently; In the case where the movement of the item 20 through these different areas does not correspond to a non-fraudulent model, then there is potentially a situation of fraud. Preferably, in addition to considering the movement of the item 20 in this compartmentalised virtual space, the present invention also considers the interactions between the item 20 and any other foreign element; advantageously, if a cloud of points, i.e. a hand or another object approaches and interacts with the cloud of points corresponding to the item 20, the suspicion of fraud increases; Preferably, if the foreign element is a hand identified as empty, then the suspicion of fraud could be reduced.
c. A step for assessing a probability of fraud, this probability being non-zero if:
   i. A handling anomaly is identified; and/or
   ii. Preferably, a weight anomaly is identified.

It should be noted that a probability of fraud could correspond to a binary piece of data such as for example 1 or 0, 1 corresponding to the fact that the fraud is certain and 0 corresponding to the fact that there is no fraud. According to another embodiment, a probability of fraud could correspond to a percentage of fraud, for example an absence of fraud is equivalent to 0% and a certainty of fraud to 100%.

Thus, a fraud probability could be a numerical value between 0 and 100 and/or be a binary value equal to 0 or 1.

This fraud assessment step consists in cross-checking a plurality of data so as to assess a probability of fraud, in particular if a weight and/or handling anomaly is detected. Advantageously, this cross-checking of data is carried out by an artificial intelligence module 1420 preferably comprising a trained neural network, preferably automatically.

Some situations could be easily identified as fraud, nevertheless, other situations could sometimes be too complex for fully automated processing at low cost. Also, in order to reduce the costs of a highly automated analysis system, but the cost of which would be very high, the present invention proposes a hybrid solution in which a portion of the analysis is carried out automatically and another portion is carried out via the intervention of supervisors where necessary.

Thus, cleverly, and as indicated before, the present invention may comprise at least one mobile analysis device 1700 intended to be used by at least one supervisor.

According to one embodiment, the mobile analysis device 1700 is configured to receive a plurality of data from the computer processing unit 1400 and/or from a management station 1600 which will be described later on.

Cleverly, the mobile analysis device 1700 is configured to display at least part of these data in a form enabling quick decision-making, for example in less than 10 seconds, preferably in less than 5 seconds and advantageously in less than 2 seconds, from the supervisor.

Thus, the objective is to send the most qualitative information to the supervisors, preferably for remote control.

For this purpose, the computer processing unit 1400 selects a selection of images from the plurality of collected images and transmits this selection to the mobile analysis device 1700. This selection is advantageously carried out by considering particular time points, for example the time point of the scan, of the weighing, of the movement of the item 20, of the entry or exit of an area, etc. . . . .

According to one embodiment, the computer processing unit 1400 makes a video, preferably temporally compressed, which it also transmits to the mobile analysis device 1700. A temporally compressed video should be understood as a video whose number of images per second is greater than 24 for example, and possibly a video whose playback time from start to end is less than the duration of the illustrated action, we also speak of time lapse video and possibly accelerated video. Advantageously, this video also comprises, preferably over its timeframe, the notification of the particular time points mentioned before, for example, in the form of markers. This enables the supervisor to select, if he wishes, a specific passage of the video relating to a particular event which is located there. This makes it easy, intuitive and quick to select an event and access the passage of the video and preferably other data related to this event.

Finally, the computer processing unit 1400 transmits to the mobile analysis device 1700 the information related to the scanned item 20 and/or a text explaining the detected anomaly or anomalies, and possibly the type of fraud that is suspected and/or detected.

Preferably, the computer processing unit 1400 transmits this data either directly to the mobile analysis device 1700, or via a computer server 1600. This computer server 1600 is advantageously configured to conform the data to be transmitted so as, for example, to prioritise them according to various prioritisation parameters and/or to sort them, for example.

According to one embodiment, this computer server is an integral part of a management station 1600.

According to one embodiment, when fraud is suspected, the computer processing unit 1400 transmits said data to at least one management station 1600 via a computer server for example, then an employee, called super-supervisor for example, is then in charge of analysing whether there is fraud or not.

In the case where there is no fraud, a validation command is transmitted to the computer processing unit 1400 validating the action of the user. In the case where a certainty of fraud or a doubt remains, the super-supervisor transmits the considered data to the analysis device 1700 of the supervisor. This supervisor is advantageously mobile and could thus approach the user whose action seems to be fraudulent. Thus, the supervisor is intended to take charge of the situation, on the one hand by analysing said data and on the other hand by moving to the place of the possible fraud.

According to one embodiment, the mobile analysis device 1700 may for example comprise a tablet, a computer, a smartphone and possibly any medium allowing the display of data and preferably comprising an advantageously tactile interface.

According to an advantageous embodiment, the data presented on the mobile analysis device 1700 is formatted to be easily understood and analysed. In a particularly advantageous manner, the present invention proposes a clear, simple and intuitive presentation of the data enabling the supervisor to decide very quickly, preferably in less than 10 seconds, whether the situation is a situation of fraud or not.

Thus, for example, when the probability of fraud exceeds a predetermined threshold, the computer processing unit 1400 transmits the data necessary for the super-supervisor located at the management station 1600 to be able to filter out potential situations of fraud. If according to his analysis, there is no fraud, he sends a validation command to the user so that he could continue his purchases or his payment.

If according to his analysis, there is a possibility of fraud, he transfers the data to the mobile analysis device 1700 of a supervisor, preferably the one closest to the user for example.

Thus, for example, a summary of all “suspicious” actions, i.e. potentially fraudulent actions, is presented on the management station 1600 of a super-supervisor and/or on the mobile analysis device 1700 of the supervisor, for example the supervisor located at the exit of the store, so that he could interact with the user during the payment phase, for example.

Advantageously, when an action is interpreted as potentially fraudulent by the computer processing unit 1400, all the data necessary for the remote control of this situation are sent to the management station 1600, i.e. to a supervisor. This person could be a security guard, a cashier or be totally decentralised in another country where labour is less expensive, for example.

As indicated before, the super-supervisor has all the information necessary to control the action on a graphical interface. This graphical interface is advantageously configured to display the image and the title of the concerned item 20, a short description of the type of fraud detected, a sequence of images of the action, such as a comic strip for example in the form of thumbnails, and advantageously a video, preferably accelerated; the objective being that the supervisor and/or the super-supervisor could determine whether the action is fraudulent in a very short time, generally in less than 10 seconds, preferably 5 seconds and advantageously in 2 seconds.

Very cleverly, the interface and/or the conformation of the data are configured to simplify the work of the supervisor and of the super-supervisor.

Very cleverly, the present invention first uses a first automated filter, represented by the computer processing unit 1400, preferably based on the use of an artificial intelligence comprising at least one neural network, to filter the potentially fraudulent situations from the other ones, then a second filter is applied. This second filter, according to one embodiment, comprises the mobile supervisors using a mobile analysis device 1700. According to another embodiment, this second filter comprises the super-supervisors at the management station 1600, therefore the mobile supervisors using a mobile analysis device 1700 represent a third filter. The combination of these different filters makes the work of each filter increasingly easier and quicker.

It should be noted that quite advantageously, the present invention analyses the possibility of fraud on the basis of an analysis of three-dimensional scenes. In particular, the three-dimensional scenes, also called plurality of images, are collected by the stereoscopic camera 1320. These preferably dynamic 3D scenes comprise one or several pluralities of moving points. A first plurality of points corresponds to the item 20 which is then tracked in space. A second plurality of points may correspond to a user's hand or to another item. Any plurality of points which interacts, i.e. which approaches at a distance less than a predetermined threshold from the first cloud of points, is considered as a potential source of fraud.

In a particularly advantageous manner, and as specified later on, the displacement of the first plurality of points among the various areas is recorded and compared with a plurality of non-fraudulent displacement models. Should a sequence of actions do not correspond with a sequence of actions belonging to a predetermined model among the non-fraudulent models, then the probability of fraud increases.

We will now describe a plurality of standard behaviour models that could be used by the present invention to classify a behaviour.

Standard behaviour model corresponding to the addition of an item 20:
a. Identification of the item 20;
b. Definition of the geometric shape of the validated item, called “globe” hereinafter, in the scan area 1321;
c. Validated comparison of at least one two-dimensional image of the item 20 contained in the database 1410 with at least one two-dimensional image of the item 20 taken during its identification;
d. The validated item 20 leaves the scan area 1321;
e. The validated item 20 passes or not by the external area 1322;
f. The validated item 20 enters the entrance area 1324;
g. Validated comparison of the two-dimensional image of the item 20 taken during the identification of the item 20 with the two-dimensional image of the validated item 20 during passage through the entrance area 1324;
h. The validated item 20 enters the internal area 1323;
i. Measurement of the resulting increase in the weight of the container 11, i.e. a measurement of the starting weight increased by the predetermined weight of the identified item 20, this increase in weight could occur before or after the two-dimensional identification with an empty hand leaving the internal area 1323 through the entrance area 1324.

Standard behaviour model corresponding to the identification of an empty hand:
a. An empty hand enters the external area 1322;
b. An empty hand enters the entrance area 1324;
c. An empty hand in the internal area 1323;
d. Weight change or not, this weight change could occur before or after the following two events;
e. An empty hand enters the entrance area 1324;
f. An empty hand enters the external area 1322.

Standard behaviour model corresponding to the user taking, for example to look at it, an item 20 already validated and present in the container:
a. An empty hand enters the external area 1322;
b. An empty hand enters the entrance area 1324;
c. An empty hand in the internal area 1323;
d. The weight decreases, this decrease in weight possibly occurring at this time point or during the following 5 events;
e. A full hand enters the entrance area 1324, becomes the object followed by the optical device 1300;
f. The tracked object enters the external area 1322;
g. The tracked object enters the entrance area 1324;
h. Validated two-dimensional comparison between the two-dimensional image of the tracked object during the first pass through the entrance area 1324 with the two-dimensional image of the tracked object during the second pass through the entrance area 1324;
i. The tracked object enters the internal area 1323;
j. The weight increases accordingly, i.e. it returns to the starting weight, this increase in weight possibly occurring between this time point and the end of the model;
k. An empty hand enters the entrance area 1324;
l. An empty hand enters the external area 1322.

Standard behaviour model corresponding to the user setting an item 20, and forgetting to identify it:
a. A full hand enters the entrance area 1324, becomes the tracked object;
b. The measured weight increases, this increase in weight possibly occurring at this time point or during the following 3 events;
c. An empty hand enters the entrance area 1324;
d. An empty hand enters the external area 1322;
e. An empty hand enters the entrance area 1324;
f. An empty hand enters the internal area 1323;
g. The weight decreases, as a result, i.e. it returns to the starting weight of the model, this decrease in weight possibly occurring between this time point and the end of the model;
h. The tracked object enters the entrance area 1324,
i. Validated two-dimensional comparison between the two-dimensional image of the object tracked during the first pass through the entrance area with the two-dimensional image of the object tracked during the second pass through the entrance area 1324;
j. The tracked object enters the external area 1322.

Standard behaviour model corresponding to the removal of an item 20:
a. An empty hand enters the external area 1322;
b. An empty hand enters the entrance area 1324;
c. An empty hand enters the internal area 1323;
d. The weight decreases, this decrease in weight possibly occurring between this time point and the end of the model;
e. A full hand enters the entrance area 1324, becomes the tracked object;
f. The tracked object enters the external area 1322;
g. The tracked object enters the scan area 1321;
h. Identification of an item 20 of the virtual basket selected as being an item 20 to be removed by the user;
i. Validated two-dimensional comparison between the image of the item 20 during its identification and the image of the object tracked during its passage through the entrance area 1324.

Finally, it should be noted that from the time point when an element external to the item 20 and preferably to an empty hand comes into contact with the validated item 20 or the tracked object or enters the internal area 1323, during the steps of a model, fraud might then be suspected.

Similarly, if during a sequence of events, the item 20 or the tracked object leaves the field of view of the optical device 1300, fraud might be suspected.

The present invention advantageously takes advantage of these standard behaviour models. Indeed, instead of trying to classify a sequence of events as fraudulent, it is simpler and faster to compare a sequence of events to a series of models considered as non-fraudulent. Whenever there is a difference above a predetermined threshold between the assessed behaviour and a standard behaviour model, fraud is suspected. If so, it is upon one or several super-supervisor(s) or supervisor(s) to intervene.

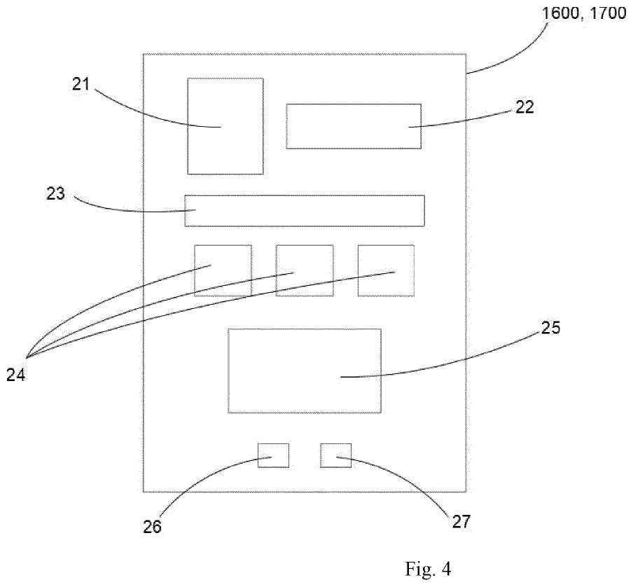

FIG. 4 illustrates, according to an embodiment of the present invention, an interface of a management station 1600 and/or a mobile analysis device 1700. This interface is advantageously tactile. This interface comprises a smart graphical interface.

This graphical interface comprises a graphical representation 21 of the item 20, as well as optionally a description 22, preferably short and concise. This graphical interface comprises a simple and synthetic description of the potential type of fraud 23. This graphical interface may comprise a plurality of images in the form of thumbnails 24 which could for example represent specific and relevant actions of the user taking into account the type of estimated fraud. This graphical interface preferably comprises a video, advantageously temporally compressed, as described before.

Advantageously, the graphical interface comprises at least a first actuator 26 and at least a second actuator 27. The first actuator 26 may for example be configured to enable the supervisor or the super-supervisor to indicate that there is no fraud. The second actuator 27 may for example be configured to enable the supervisor or the super-supervisor to validate that there is a situation of fraud. According to one embodiment, the graphical interface of the management station 1600 may comprise a third actuator, not illustrated in this figure, configured to transmit the analysis of the data to the mobile supervisor through a mobile analysis device 1700 so that he could go on site and validate or not a situation of fraud.

Advantageously, if the user has no action reported as potentially fraudulent by the computer processing unit 1400 and/or no action reported as fraudulent by the supervisor and/or the super-supervisor, then he could pay without any interruption, the purpose being that a user who does not cheat is absolutely not disturbed during his purchase session.

Advantageously, if a fraud is reported by a supervisor and/or a super-supervisor, then:
a. The user is notified and waits for the arrival of a supervisor; and/or
b. The payment phase is interrupted pending the arrival of a supervisor;

In any situation, in case of doubt or validated fraud, a supervisor is in charge of moving to the user and checking the item(s) to which the probability of fraud relates. In this way, the check-up of the supervisor is quick and directly oriented towards one or several item(s) among several others.

Finally, once the user initiates the payment phase, if no action is reported as fraudulent or potentially fraudulent by the supervisors and/or the super-supervisors preferably located remotely, the payment is validated.

In addition to a clever presentation, and as mentioned before, according to one embodiment, the present invention also proposes a clever way for hierarchising the data and the situations of potential fraud to be processed.

We will now list non-limiting examples of priorities taken into account in the presentation of information to the supervisors and super-supervisors:
a. The actions of a user in the payment mode should be shown in absolute priority, i.e. a potential fraud situation involving a user in the payment phase has priority;
b. The longer a user's purchase session lasts, the higher their actions are prioritised, because their chances of finishing their purchases increase;
c. The lower the probability of fraud of an action, the higher it is prioritised, because non-fraudulent users don't have to wait or be slowed down to pay;
d. Similarly, a user who has very few suspicious actions will be checked first.

Thus, the present invention cleverly crosses several data to assess a probability of fraud, then this data is cleverly conformed and each situation prioritised to allow for fluidity to the user experience and a high responsiveness of the supervisors and/or super-supervisors.

We will now specify a point of the analysis of the data that the present invention implements. Indeed, we have previously indicated that the plurality of collected images is analysed.

Thus, according to a preferred embodiment, the processing of the plurality of data comprises processing of a plurality of collected images, which may comprise two-dimensional images, preferably in colour, and three-dimensional images. This processing is advantageously carried out by the computer processing unit 1400 which is preferably embedded in a mobile element such as the cart 10 described before.

According to one embodiment, the cart 10, at least the computer processing unit 1400, should analyse scenes acquired by several sensors; a so-called two-dimensional camera 1310, advantageously a wide-angle one; a so-called stereoscopic 3D camera 1320; a gyroscope; a measuring device 1200; an identification device 1100; etc. . . . .

The analysis of these scenes generally requires a lot of system resources, therefore computing power, and therefore energy. Nonetheless, the system 1000 according to the present invention is cleverly designed to do this type of processing with little energy, few system resources and quickly.

Indeed, according to one embodiment, this processing could be shifted to a computer server in order to reduce the electrical consumption, but also the system resources used by the cart 10.

According to another embodiment, and in particular when the cart 10 is not connected to a computer server, the processing should be done directly with the system resources and the energy available in the cart 10.

The present invention is designed so as to limit the costs and energy of an anti-fraud solution. To this end, the analysis of the scenes is not necessarily a priority in terms of time, i.e. this analysis does not need to be carried out in real-time. This is, inter alia, how the present invention offers a clever solution.

According to one embodiment, the method of the present invention comprises a step of recording the scenes by all sensors on a video, in order to analyse them a posteriori.

Preferably, under some conditions, the two-dimensional and three-dimensional video recording begins, i.e. the two-dimensional and three-dimensional image collection, when there is an object in an area of the previously defined space, for example in the entrance 1324 or scan 1321 area, and possibly in the external area 1322.

According to one embodiment, the data measured or collected by the other sensors are recorded at the accurate time point of each event.

Advantageously, each event is temporally inset, for example, via metadata in the video. Thus, for example, every scan and every resulting weight change is recorded and noted in the video.

Advantageously, the present invention is configured to generate a timeframe comprising events that could be selected from among: 2D images, 3D images, identification, weight variation, and more generally any measurement by one of the sensors. Thus, this timeframe allows representing the events that have occurred chronologically.

Thus, this enriched timeframe saves time in the analysis of a potential situation of fraud.

Advantageously, the recording of this video is defined by the capture of points in a given space.

According to one embodiment, when the recording starts, it takes into account the previous X seconds in order to have information related to the scene before the event that triggered the recording, i.e. the video record, also known as temporally compressed video, begins with the action that triggered its recording. For this purpose, and as presented before, the system permanently records a predetermined duration, for example 5 seconds, which it gradually deletes. Thus, it records 5 seconds of data for example and erases them after 5 seconds unless an event is detected involving the start of recording for analysis a posteriori, the images recorded before this event are then taken into account in the generation of the temporally compressed video.

According to one embodiment, the start of this recording is subject to a change of state of at least one sensor selected from among all the sensors of the system. As a reminder, the sensors of the system are selected from at least: the identification device 1100, the measuring device 1200, the optical device 1300, a motion sensor, a gyroscope, a spatial positioning sensor, an accelerometer, etc.

Advantageously, the sensor may be a virtual sensor, i.e. a virtual event such as the passage of a cloud of points from one spatial area to another spatial area. For example, when the item 20 crosses the entrance area 1324, this crossing could be considered as a change of state, the analysis of the 3D scene therefore serving as a virtual sensor.

Thus, when an event is detected, captured and possibly measured by one of the sensors of the system, said recording is carried out, preferably via the collection of a plurality of images and data from the various sensors. It should be noted that preferably all of the measurements of each sensor are recorded.

For example, when a scan is in progress, an increase in the weight of the container is expected as a result or when a scan is cancelled, or when the weight has varied and the system is waiting to return to a stable state, these are examples of events leading to the start of data recording.

According to one embodiment, a first recording could be launched when the previously listed conditions are present, then, if there is an absence of user actions, for example after a predetermined time period, then the first recording stops. And a second recording starts as soon as the user performs a new action. Nonetheless, the final analysis comprises the analysis of the first record and of the second record even if this analysis is done on a timeframe comprising one or several time gap(s), i.e. one or several period(s) not recorded as there were no actions.

For example, when a user places an item 20 without scanning it, the recording will start, but if the user leaves and does not take any action after 10 seconds for example, the recording will stop, and a new recording will start as soon as an action is detected. However, the analysis will be done while considering the two records, because the analysis is done only when the cart 10 becomes stable again, it will however have a gap in the data record.

Thus, advantageously, an analysis could cover several records.

And preferably, the same record could be used for several different analyses.

The start of the recording could also be launched by the three-dimensional capture of the crossing of the entrance area 1324 by the cart 10 for example.

A stable state is defined when all of the sensors do not detect a measurement variation greater than a predetermined threshold, this threshold could depend on each sensor. Hence, an unstable situation is defined as corresponding to the detection of a measurement variation by at least one of the sensors greater than said predetermined threshold, preferably specific to said sensor. It should be noted that the scan of an item is considered as an unstable state by the present invention.

From the time point there has been a switch into an unstable state, all of the video records, as well as the acquisitions of the sensors included in the temporally compressed video of this unstable state are analysed a posteriori. Indeed, when an unstable state is detected, the system resources are primarily dedicated to data collection. Once this unstable state is over, the collected data are processed, i.e. the temporally compressed video, comprising the acquisitions of the different sensors, is analysed by the computer processing unit 1400. This allows smartly allocating the limited system resources between data collection and analysis thereof. This allows keeping production costs and energy consumption low.

We will now describe an example of implementation of the optical analysis proposed by the present invention.

In a particularly clever way, and as mentioned before, tracking of the item 20 and/or of the hand or hands of the user is triggered following the scan of said item 20. Similarly, the tracking of an item 20 could be triggered when the user takes an item out of the container 11 given the detection of the change in weight by the measuring device 1200.

Preferably, after the scan of an item 20, the three-dimensional shape of the item 20, also called an object, is rebuilt, preferably in two portions, this three-dimensional shape will be called “validated shape”. The first portion of this validated shape is the end of the shape that we will call the “globe” which represents the item and the hand. The second portion of this shape is the arm and potentially a portion of the body of the user.

We will describe the operation of this optical analysis using the example of a person buying an item 20. This optical analysis enables the identification of what we have called a handling anomaly. Once the scan has been performed, the shape present in the scan area 1321 becomes the validated shape and the globe is the end thereof. The globe should move from the scan area 1321 to the external area 1322, then pass through the entrance area 1324 and disappear into the internal area 1323. Afterwards, the item is supposed to be deposited in the container 11, and therefore a variation in weight should be measured, finally the globe comes out through the entrance area. The globe could also pass directly from the scan area 1321 to the entrance area 1324.

Afterwards, a two-dimensional analysis of the images of the 2D camera 1310 through a neural network is carried out in order to verify that the globe which comes out of the container after the deposit of the item 20 in the container 11 actually corresponds to an empty hand. If the analysis detects an empty hand passing through the entrance area 1324 and towards the external area 1322, then there is no fraud. The same situation applies if the analysis detects an empty hand after measuring an increase in weight consistent with the identifier of the item 20, then there is no fraud.

On the other hand, upon the two-dimensional analysis of the images from the 2D camera 1310, if the leaving globe is detected as being a “full hand” by the neural network, this means that the hand comes out full, so that there is a potential fraud.

Let us remember here that several actions could suggest that there has been a fraud after a scan to add an item 20, such as, for example, if another unknown shape comes too close to the validated shape (to exchange the item for example), or if a shape obstructs the camera or if an unknown shape enters the entrance area 1324.

Advantageously, during the two-dimensional analysis, if the unknown shape is identified as an empty hand, the probability of fraud could be nuanced, and possibly zero.

Cleverly, if the measuring device 1200 detects a deposition action, i.e. an increase in the weight of the container 11, while the validated shape is still in the external area 1322, one could deduce a strong probability of fraud via the detection of a handling anomaly.

In the case of a removal, the scenario without fraud is the same, but in the other direction, i.e. a hand identified as empty recovers an item 20 whose weight is subtracted from that of the container 11 and this item 20 is then scanned, the correspondence between the predetermined weight and the less measured weight confirms the absence of fraud for example. Conversely, if a weight is removed without a subsequent scan or if the weight of the scanned item 20 does not correspond to the removed weight, the probability of fraud increases.

In the case where an unscanned item 20 is deposited in the container 11, the system 1000 will detect a full hand via the two-dimensional analysis, this hand crossing the entrance area 1324, and possibly the internal area 1323, and the measuring device 1200 will detect an increase in the weight of the container 11 and its contents. Thus, no item 20 having been scanned prior to this weight increase, the probability of a weight anomaly, i.e. fraud, is high. In the case where a full hand is detected crossing the entrance area 1324 for example, and possibly the internal area 1323 without prior scanning, a handling anomaly is detected, and the probability of fraud increases.

Similarly, if for example the measuring device 1200 detects an increase in weight, this means that a deposit action has been performed, and if no scan has been performed, the probability of fraud increases.

In the case where an empty hand enters, then an item 20 is removed and a full hand leaves the internal area 1323, the leaving shape becomes what we will call a tracked shape, i.e. the shape followed by the optical device 1300.

In the case where the tracked shape does not leave the field of view of the optical device 1300 and re-enters the internal area 1323 without an unknown shape approaching it, without entering the entrance area 1324 or without the optical device 1300 being obstructed, there is no handling anomaly and the probability of fraud is low.

Preferably, this action being all the same suspicious, the present invention provides for a two-dimensional comparison of the taken out item 20 and the returned item 20.

In the case where a tracked shape, and possibly a validated shape, leaves the field of the optical device 1300, the function of the system 1000 is to find this shape when the shape enters again in the field of view of the optical device 1300.

Advantageously, the system 1000 comprises a so-called “wide-angle” two-dimensional camera 1310, i.e. having an optical angle larger than 100 degrees. This 2D camera 1310 is configured to also ensure this tracking function.

Advantageously, the optical device comprises an additional 2D camera configured to cooperate with the 3D camera. Indeed, the additional 2D camera is configured to collect two-dimensional images of the three-dimensional scene.

According to one embodiment, the optical device 1300 comprises a plurality of 3D cameras 1320 and 2D cameras 1310, and possibly additional 2D cameras.

Thus, when a shape is tracked, for example via the stereoscopic camera 1320, its two-dimensional aspect observed via the additional 2D camera is “learned” by automatic training of a neural network via a technique of the “machine learning” type, a term indicating automatic training. Simultaneously, its position on the three-dimensional camera 1320 is synchronised on the two-dimensional camera 1310.

The objective being that when the object or the item 20 leaves the field of the 3D camera 1320, the 2D camera 1310 “knows” its appearance, its geometric shape, and its position at the exit in order to continue to track the object on the 2D camera 1310.

Thus, the three-dimensional camera 1320 enables the system 1000 to learn the shape of the tracked item and track its position in space, this learned shape and this known position are then transmitted to the two-dimensional camera 1310 for tracking over a larger area, as soon as the item 20 leaves the monitoring area of the three-dimensional camera 1320.

The goal being that when the item 20, or more generally the tracked object, re-enters the field of the three-dimensional camera 1320, the 2D camera 1310 could communicate its position thereto as well as its aspect in return, so that the 3D camera 1320 could resume its monitoring, and possibly improve its learning, for example.

According to one embodiment, an analysis could be done on the 2D camera 1310 in order to know whether a full hand or an empty hand has approached the tracked item 20, or the object. The term item or object is used independently to define item 20.

In the case where a hand has approached the tracked item 20, the probability of fraud increases. According to one embodiment, the present invention comprises a double check mode. This mode is to be set up when there is a doubt concerning a fraud. This mode consists in transmitting a request to the user to scan again an item 20 that is supposed to be in the container 11, a few minutes after he has inserted it or during his payment.

In the case where there is no fraud, the normal course should be that an empty hand enters the container 11, that a weight corresponding to the requested item 20 should be removed by the full hand which should remove the item 20, the scanner; then the item 20 is then put back in place, the measured weight of the container 11 and its contents should therefore rise and finally an empty hand should come out. If this does not happen, fraud might be suspected, the probability of fraud could then increase.

There is a technique to counter the anti-fraud systems of the prior art based solely on the measurement of weight. This consists in replacing the label, more generally the barcode of the item 20. For this purpose, for example, the item 20 is weighed in the store on a fruit and vegetable scale, then the label corresponding to a piece of fruit, for example, is stuck on the item 20. This label indicates the correct weight, but not the correct item 20, at the level of the automatic checkout for example, the user will scan the item 20, and place it on a scale, the system of the prior art has no means for detecting the fraud that is taking place.

The present invention provides an effective solution to this type of fraud. Indeed, to defeat this type of fraud, the present invention suggests taking photos in the direction of the item 20 from different angles. During a scan, these photos have a double use:
a. Firstly, these photos are used to feed a neural network model linked to the identifier of the item 20, for example to its barcode. Afterwards, this neural network is configured to indicate whether the item 20 is present on an image taken by the optical device 1300 or not. This is done by comparing the photo just taken and all of the other photos taken during a scan for the same item 20 for example.
b. Secondly, the photos pass through the neural network model and the output of said network is a probability of conformity between the scanned item 20 and the expected item 20 with regards to its identifier, in order to estimate whether the scanned barcode actually corresponds to the item 20 of the photo.

According to one embodiment, the label exchange being done most often with fruits and vegetables, the neural network is trained to identify a bag of fruits and/or vegetables, and if during a scan of a “fruits and vegetables” barcode, the optical device 1300 does not recognise a bag of this type, then fraud is suspected.

In a particularly clever and counter-intuitive way, the database may comprise a score per item corresponding to the fact that it is a cheap item and therefore regularly used to carry out fraud, either by using the label of such an item, or its packaging, for example without limitation. Also, preferably, these inexpensive items have a higher fraud score than luxury items.

According to another embodiment, luxury items have a higher fraud score than other items.

It should be noted that when the probability of fraud exceeds a predetermined threshold, fraud is considered, and it is then up to the super-supervisor and/or the supervisor to intervene by confirming the fraud, or by invalidating it and/or by moving to the user.

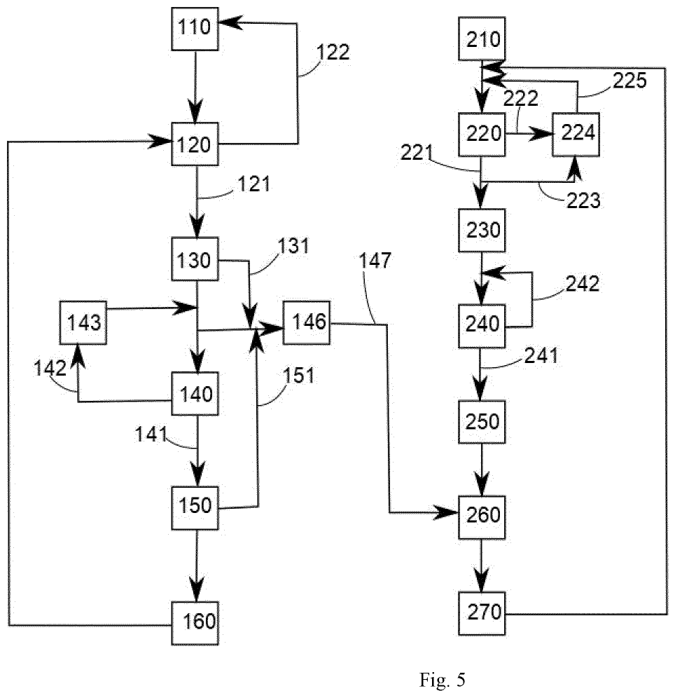

We will now describe FIG. 5 which schematically represents the data recording and processing process.

This figure illustrates two portions of a fraud detection algorithm according to an embodiment of the present invention.

We will describe it. The recording 110 of the data begins 120 as soon as an object is detected by the optical device, preferably by the stereoscopic camera and advantageously when the detected object is located in one of the areas of the three-dimensional space. If no object is detected 122, the recording remains on standby.

If there is detection 121, then the previous X seconds are stored in memory 130, 131 and recording continues after them. If an object is still present in one of the areas 140, then 142, recording continues 143.

If there is no more object in the three-dimensional space 141, X seconds are counted 150 and added 151 to the end of the recording upon completion thereof 146. Recording then stops 160.

Once the record is created, it is transmitted 147 for analysis.

The analysis 210 is in standby as long as a recording is in progress. Thus, the system monitors whether an identification is in progress 220: yes 221, no 222, whether a weight measurement is in progress 225: yes 223, no 222.

When an identification is in progress and/or the weight is unstable, the system prepares 230 to analyse a record.

If the measurements are complete, i.e. if the state of the system is again stable 240, then we carry on 241 with the definition 250 of the end of the record to be analysed, otherwise 242 we remain on standby for a stable situation to carry out the analysis. As a reminder, a situation is considered unstable as long as variations in the measurements of the sensors are detected.

Once the system is stable, the analysis 260 of the record begins. This allows using the little system resource only when the data collection phase is complete.

Afterwards, the algorithm finishes its analysis 270 and returns to its initial state of waiting for a new analysis to be carried out.

According to one embodiment, in the event of an unstable situation, while an analysis is in progress, part of the system resources allocated to the analysis is redistributed for the collection of data.

In a particularly advantageous manner, the present invention uses few system resources and little energy by separating into two distinct phases, the collection of data and the analysis of these collected data.

Thus, the present invention allows obtaining high-quality fraud detection while proposing a low-cost technical solution, the solution being optimised for a large-scale and inexpensive application.

Thus, the present invention allows solving at least the following fraud situations:
a. The user scans an item 20 and places two;
b. The user discreetly places an item 20 in the container 11 without scanning it;
c. The user scans a bottle of wine at 5€ and deposits one at 50€ of equivalent weight, and possibly one that resembles it morphologically;
d. The user swaps an unscanned item 20 with an already scanned item 20 in the container 11,
e. The user scans an item 20 with a fruit or vegetable barcode label;
f. The user puts a fragrance bottle in a fruit and vegetable bag and scans it with a fruit and vegetable barcode label.

Hence, the present invention uses the merger of several data from several sensors to determine a probability of fraud.

In a particularly advantageous manner, the present invention comprises a so-called self-learning analysis of its data, i.e. the computer processing unit is configured to automatically learn the elements forming a fraud. For example, the system is configured to learn that generally a series of actions, or that some values of the collected data lead to a situation of fraud. For this purpose, the processing unit receives as input a plurality of data and as output the situation is judged as fraud or not by the supervisors and/or the super-supervisors.

The invention is not limited to the previously-described embodiments and extends to all of the embodiments covered by the claims.

### REFERENCES

10 Mobile cart
11 container
12 Display device
13 Gripping device
14 Wheel
15 Frame
16 Electric battery
20 Item
21 Graphical representation of the item
22 Description of the item
23 Description of the potential fraud situation
24 Thumbnails
25 Temporally compressed video
26 First actuator
27 Second actuator
1000 Fraud detection system
1100 Identification device
1200 Measuring device
1300 Optical device
1310 Camera
1320 Stereoscopic camera
1321 Scan area
1322 External area
1323 Internal area
1324 Entrance area
1400 Computer processing unit
1410 Database
1420 Artificial intelligence module
1500 User interface
1600 Management station
1700 Mobile analysis device

1. A method for detecting fraud in the event of the purchase by at least one user of at least one item comprising at least:
a. a capturing step, performed by at least one user terminal, of a plurality of data from at least one sensor, the capturing step comprising at least the following steps:
i. obtainment of an identifier of the item by at least one identification device;
ii. determination by at least one optical device of at least one trajectory of the item manually moved by the user in a three-dimensional space, said three-dimensional space comprising at least:
1. an identification area corresponding to a volume of the three-dimensional space in which at least one portion of the item is intended to be disposed by the user to achieve the obtainment of the identifier of the item;
2. an entrance area corresponding to a volume of the three-dimensional space crossed by the item when the user deposits the item in at least one container associated with the user terminal);
iii. sending by the user terminal to at least one computer processing unit of:
1. the identifier of the item from the identification device;
2. the trajectory of the item;
b. a processing step performed by the computer processing unit, of the plurality of data comprising at least the following steps:
i. generation of at least one behaviour of said item from at least the trajectory of the item in the three-dimensional space;
ii. comparison of the behaviour of said item with a plurality of predetermined behaviour models so as to identify a handling anomaly by the user;
c. a step of determining a probability of fraud as a function of said behaviour comparison, this probability being non-zero if a handling anomaly has been identified.

2. The method according to claim 1, wherein the optical device is configured to enable depth to be taken into account in determining said trajectory of the item.

3. The method according to claim 1, wherein the trajectory of the item in the three-dimensional space, as determined by the optical device, comprises at least one plurality of points, each point of said plurality of points comprising at least three spatial coordinates.

4. The method according to claim 1, wherein the optical device (1300) comprises a stereoscopic optical device.

5. The method according to claim 1, wherein the step of capturing a plurality of data comprises at least one measurement, by at least one measuring device, of the weight of the item, and a step of sending by the user terminal to the computer processing unit the measured weight of the item.

6. The method according to claim 5, wherein the processing step comprises, at least the following steps:
a. identification in at least one database of the item from the identifier, the database comprising at least the identifier of the item associated with a predetermined weight of the item;
b. obtainment of the predetermined weight of the item from the database:
i. In in the event that the predetermined weight is equal to zero or is not input, the computer processing unit assigns the measured weight of the item as the predetermined weight associated with said identifier in the database;
ii. In in the case where the predetermined weight is different from zero and is input, the computer processing unit performs a comparison of the predetermined weight and the measured weight so as to identify a weight anomaly if the weight difference is greater than a predetermined threshold.

7. The method according to claim 6, wherein the determination of a probability of fraud is carried out according to said comparison of the predetermined weight with the measured weight, this probability being non-zero if a weight anomaly has been identified.

8. The method according to claim 6, wherein the predetermined weight of the item contained in the database comprises a range of weights.

9. The method according to claim 1, wherein the step of determining the trajectory of the item in the three-dimensional space comprises tracking the item in at least one area selected from among at least the identification area, the entrance area, at least one external area, at least one internal area corresponding at least to the entrance of at least one container, the entrance area separating the external area from the internal area.

10. The method according to claim 1, wherein the determination of the trajectory of the item in the three-dimensional space comprises at least the passages of the item from one area of the three-dimensional space to another area of the three-dimensional space.

11. The method according to claim 1, wherein the step of determining the trajectory of the item comprises at least the determination of the trajectory of an object other than the item moving in the three-dimensional space.

12. (canceled)

13. The method according to claim 1, wherein the behaviour generated by said item comprises at least one sequence of events detected by the plurality of sensors, these events being selected from among at least: the identification of the item, the passage from one area of the three-dimensional space to another area of the three-dimensional space, the measurement of the weight of the item, the approach of the item by another object.

14. The method according to claim 1, wherein the step of capturing the plurality of data comprises the collection by the optical device of a plurality of images at least of the item and at least of a hand of the user carrying the item.

15. (canceled)

16. The method according to claim 14, wherein the processing step comprises at least one comparison of an image of the item present in the database and one or more images of the plurality of collected images so as to identify an anomaly between the image of the item of the database and the collected image(s) of the item.

17. (canceled)

18. (canceled)

19. (canceled)

20. The method according to claim 1, wherein the step of determining the trajectory of the item comprises at least:
The collection of a plurality of two-dimensional images carried out by at least one camera and by at least one additional camera;
The collection of a plurality of three-dimensional images carried out by at least one stereoscopic camera.

21. (canceled)

22. The method according to claim 20, wherein the stereoscopic camera is configured to spatially track the item in the three-dimensional space, and wherein the additional camera is configured to transmit a plurality of two-dimensional images to at least one neural network so as to train said neural network to recognise the geometric shape of the item, the spatial position of the item and its geometric shape are then used for tracking the item by the two-dimensional camera when the item leaves the field of view of the stereoscopic camera.

23. (canceled)

24. (canceled)

25. The method according to claim 1, wherein a handling anomaly comprises at least one of the following situations: exchange of the item with another item, addition of another item in a container together with said item, removal of another item from said container upon deposition of said item in said container, exchange of an identified item with another unidentified item, identification of an item with a fraudulent identifier.

26. (canceled)

27. (canceled)

28. (canceled)

29. (canceled)

30. (canceled)

31. (canceled)

32. (canceled)

33. A system for detecting at least one fraud in the event of the purchase by a user of at least one item in a store, comprising at least:
a user terminal comprising at least:
i. an identification device configured to identify the item when a user passes the item in the proximity of the identification device;
ii. a measuring device configured to measure the weight of the item;
iii. an optical device configured at least to determine at least one trajectory of the item manually moved by the user in the three-dimensional space;
a computer processing unit in communication with at least the user terminal, the computer processing unit being remote or not from the user terminal and being configured to:
i. generate at least one behaviour of said item at least from the trajectory of the item in the three-dimensional space;
ii. compare the behaviour of said item with a plurality of predetermined behaviour models so as to identify a handling anomaly;
so as to determine a probability of fraud as a function of said behaviour comparison, this probability being non-zero if a handling anomaly has been identified.

34. The system according to claim 33, wherein the computer processing unit is further in communication with a database comprising the identifier of the item associated with a predetermined weight of the item.

35. The system according to claim 34, wherein the computer processing unit is further configured to:
compare the predetermined weight of the item obtained from the database with the measured weight so as to identify a weight anomaly if the weight difference is greater than a predetermined threshold;
determine a probability of fraud according to said weight comparison, this probability being non-zero if a weight anomaly has been identified.

36. The system according to claim 33, wherein the user terminal is a mobile cart.

37. The system according to claim 36, wherein at least one portion of the computer processing unit is embedded in the mobile cart.

38. The system according to claim 33, wherein the user terminal is a fixed terminal.

39. The system according to claim 33, wherein the computer processing unit is in communication with at least one classification module comprising at least one neural network trained to detect a fraud situation based on data transmitted to the computer processing unit.

40. The system according to claim 33, wherein the user terminal comprises at least one display device configured to display at least the identifier and/or the weight of the item.

41. A computer program product comprising instructions which, when performed by at least one processor, executes at least the steps of the method according to claim 1.
